(19) United States
(12) Patent Application Publication
(10) Pub. No.: US 2004/0253398 A1
(43) Pub. Date: Dec. 16, 2004

(54) Laminated casing or netting for proteinaceous products

(76) Inventor: Neil Mintz, Carlsbad, CA (US)

Correspondence Address: GORDON & REES LLP, 101 WEST BROADWAY, SUITE 1600, SAN DIEGO, CA, 92101, US

(21) Appl. No.: 10/461,305

(22) Filed: Jun. 13, 2003

(51) Int. Cl. B32B 1/08

(52) U.S. Cl. 428/34.8; 428/36.91

(57) ABSTRACT

A casing for containment of a proteinaceous product during or following processing is described. The casing has controlled porosity which permits close control of product drying with protein retention, providing good product color and surface texture, patterned and/or shaped products, high protein content and high peelability. The casing is a hollow tubular laminate of an outer lamina having high strength and, optionally, surface pattern-producing capability, and an inner laminate of controlled porosity which is permeable by vapors and, in most cases, also aqueous and organic liquids, but which is not permeable to solids such as proteins or fats. The laminae are adhered by an adhesive (preferably thermally activated) or by surface interlocking. Accessory materials such as liquid flavorants, colorants, release agents and anti-microbial agents can be incorporated into the laminae and from there imparted to the product. Applicable proteinaceous products include meat, poultry, seafood, soya and cheese.

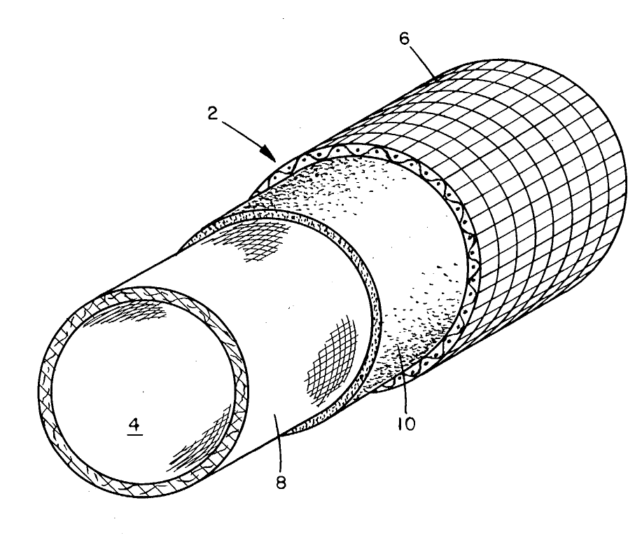

### BACKGROUND OF THE INVENTION

1. Field of Invention

The invention relates generally to casings and nettings for the formation of proteinaceous products, and more particularly for casings and nettings in which such a product is cooked, smoked, chilled, packaged or otherwise processed for market.

2. Background Information

The principal proteinaceous products of interest in the present invention are meat, poultry, seafood, soya and cheeses. For brevity herein these will be exemplified by meat and the description below will refer to “meat” as the product with which the novel casings and nettings will be used. (Meat itself is considered to encompass both white and red meats, and to include but not be limited to beef, veal, mutton, lamb, pork and game meats, whether in whole, separated, cut, ground or other recognized forms.) It will be understood, however, notwithstanding the references to “meat,” that all of the proteinaceous products are intended to be included within the scope of this invention, including not only meat but also the aforesaid poultry, seafood and cheese, and also those less commercially known proteinaceous products such as soya products. Therefore, in the description below the use of “meat” as the exemplified product should not be construed as limiting unless the context so demands.

Casings and nettings are commonly used to encase meat products through the cooking and/or smoking processes, by which the products are prepared for market. Various types of casings and nettings are used, depending on the functions desired, such as the ability to define the finished shape of the product or to impart patterns to the meat surface, and on the properties of the meats involved. Casings such as fibrous (i.e., fiber reinforced cellulose; see U.S. Pat. No. 4,164,536 [Bentley]), cellulose and collagen have sufficient desired porosity to permit smoking of the meat through the casings while allowing water vapor to escape during the cooking and smoking process; but the porosity is limited so as to prevent the contained meat emulsion from escaping. However, such casings do not impart a surface pattern or natural shape to the meat. Nettings rather than casings are used where a surface pattern or natural shape is desired. However, since nettings have a higher porosity than casings, they have significant drawbacks when used on boneless meat products containing emulsion. Meat processors using even closely knitted nettings such as described in U.S. Pat. No. 5,413,148 (Mintz et al.) and U.S. Pat. No. 5,855,231 (Mintz) have experienced peeling difficulties on emulsion-containing meat products.

Other methods to obtain the desired porosity while still offering the desired surface pattern have been tried, such as applying elastic netting in conjunction with collagen film onto the meat products. The collagen film, having the desired porosity, cooks onto the meat and becomes the edible surface, but allows the elastic netting to be easily removed after cooking. However, this method has the drawbacks of producing a tough rind surface from the collagen, poor machineablity (i.e., the ability to be used on high speed meat stuffing equipment) and high cost.

It would therefore be of substantial interest within the meat production and packing field to provide a casing that would have the synergistic effect of combining the positive properties of low porosity casings and high porosity nettings, such that the casing would have controlled porosity, be durable and peelable from the meat without damage to the meat, provide good meat product color, maintain protein content and not adversely affect cooking and chilling yields.

### SUMMARY OF THE INVENTION

The invention described and claimed herein is a new type of casing device/product which synergistically combines the best properties of high porosity nettings and lower porosity casings to provide controlled porosity during processing of the meat. Meat products cooked or smoked (as well as subsequently chilled or packaged) in the casing products of this invention have desired degrees of dryness, good color and surface texture, optionally patterned and/or shaped products, high protein content and good peelability. It has not previously been possible to obtain all of these capabilities in a single casing product.

The invention to which these properties pertain is a novel casing product which is a hollow tubular laminate of an outer lamina having high strength and, optionally, surface pattern-producing capability, including the capability to produce three-dimensional patterns, and an inner lamina of controlled porosity. The inner lamina's porosity is controlled during formation such that during processing (stuffing, cooking, smoking, chilling and the like) it allows passage through it for non-solid materials but not for solid materials. The two types of materials can be identified and differentiated by their physical state as liquid or vapor (i.e., non-solid) on one hand and solid on the other. Materials of most interest are the proteins and fats exuded by the meat product during processing, and flavorants and colorants (such as liquid smoke and/or caramel coloring) which may be incorporated into the meat or added within the casing during processing. By this controlled porosity the meat product can be cooked or smoked to a desired degree of dryness with desired retention of proteins and fats. The retention of the proteins results in elimination of protein buildup on the exterior of the casing, which in turn results in good surface quality and color of the meat product upon peeling of the casing, since there are no evolved protein masses to tear away the meat surface. Retention of fats will be a function of both the controlled porosity of the laminae and the temperature of the processing. (As will be described below, some suitable lamina materials will pass vapors but not liquids while others will pass both. For convenience herein both liquids and vapors are frequently mentioned together with respect to the lamina materials. The reader skilled in the art will recognize that when the context is specific to the “vapor-permeable-only” materials, only vapor passage is intended.)

The outer lamina is a highly porous knitted fabric such as jersey or similar fabrics. The yarn and structure of the outer fabric will be of sufficient strength, weight and resistance to stretching to provide shape and any surface design to the meat product. These knitted tubular fabrics can be made of a variety of fibers including nylon, cotton, rayon, acrylic, polyolefin and covered rubber, but the preferred fiber is polyester. The inner lamina is a thin porous sheeting material that is impervious to meat solids but which is porous to non-solid passage of vapor and also, in many cases, liquid, including water and aqueous- and organic-based liquids. This permits adequate drying of the meat by evaporation of water from the meat and also passage into the meat of desired liquids and vapors such as smoke. The inner lamina must also have good wet strength to enable liquid and vapor passage without deterioration of the lamina. Suitable inner lamina materials include but are not limited to nonwoven filter media (including open width nonwoven filter media); high wet strength papers, such as papers made from wood fiber pulp (which may include high wet strength agents such as polyamidol epichlorohydrin or melamine-formaldehyde resin), cotton fibers, or fibers such as abaca pulp (also known as Manila hemp), which are frequently used as filter media or separating membranes, particularly those which are used for teabags or fibrous casings; cellulosic films and polymeric films (including microporous films made of polyolefin, nylon or polyester). Most of the latter two will be permeable only to vapor rather than to both vapor and liquid.

Adhesion of the laminae is through an adhesive material or self-bonding of the laminae. An adhesive material can be a pressure sensitive contact adhesive material which adheres to each lamina surface upon contact and application of pressure to the adhesive and lamina, or it can be an adhesive which is activated by application of heat or radiation or by use of an activating solvent or chemical, such as by application of water. Preferred is a heat activated adhesive such as polyethylene, polypropylene, ethylene vinyl alcohol, and the like.

Details of the invention and further descriptions will be found below.

### BRIEF DESCRIPTION OF THE DRAWINGS

The single FIGURE of the drawings is an oblique schematic diagram illustrating the layers and configuration of the laminated casing or netting.

### DETAILED DESCRIPTION AND PREFERRED EMBODIMENTS

The invention described and claimed herein overcomes the deficiencies of the prior art casings and nettings by synergistically combining the desirable properties of two different materials into a single laminated device. In its broadest form, the invention is defined as a novel tubular food casing/netting device in which an outer lamina of high strength and shape-forming capability is laminated to an inner lamina of a controlled porosity material. The outer lamina's strength is sufficient to maintain a desired outer dimension and to define and maintain the shape of the food product. The inner lamina's controlled porosity is such that non-solids (vapor and also usually liquid) can pass through it to and from the cooking meat but solids within the meat are retained. This permits the meat to achieve a desired degree of dryness but still retain important solid components such as the meat proteins and much or all of the meat fats. The laminae are adhered to each other by an adhesive material or by fusion of the contacting surfaces of the laminae. Each of the lamina will be described in more detail below, particularly with reference to the FIGURE of the drawings.

For brevity herein, the overall product will be referred to generally as a “casing” which will for the most part be considered to encompass a “netting.” Only in a context where the respective properties of the individual laminae are of significance will either “casing” or “netting” be used in its more limited and specific meaning. The person skilled in the art will therefore be aware that the term “casing” as used herein should be considered to refer to the overall device of the invention unless the context demands otherwise.

Considering then the FIGURE, the casing 2 is of an elongated tubular shape having a hollow central axial passage 4 in the manner of prior art casings generally (see, e.g., the aforementioned U.S. Pat. No. 5,855,231). The internal and external cross-section of the casing 2 will commonly be circular, oval or elliptical, depending on the nature of the meat product being contained, but may be of irregular shape when containing products such as whole or partial hams or poultry. In the latter case, however, it has been found that to a significant extent the meat product conforms to the casing and the casing imparts shape to the product. The product may also be formed into geometrical cross-sections such as square, rectangular or polygonal shapes by mechanical constraining means such as molds. The latter is particularly true for meat products which are formed from ground, chopped or otherwise comminuted meats, such as sausage, hamburger or the like.

The outer lamina or layer 6 is preferably made of a highly porous knitted fabric such as jersey or similar fabrics. The yarn and structure of the outer fabric will be of sufficient strength and resistance to stretching to provide shape and any surface design to the meat product. The tightness of the woven structure may be anything from quite open to fairly tight or closely woven; typical open weave materials are elastic netting and a material known commercially as “versonet,” while the Mintz patents described below illustrate tighter or more closely woven fabrics. The yarn and structure provide the strength needed to withstand the stuffing pressure of the filling meat, since the meat must be stuffed into the casing under sufficient pressure to eliminate internal voids and give a consistent shape. It is also known to incorporate separate stronger and/or heavier strands into the outer fabric to assist in imparting a desired surface pattern and/or definition to the meat product. A number of different surface patterns having been imparted to meat products in the prior art, the most common being rectangles or squares. Additional patterns such as spiral windings, diamonds, triangles, polygons such as hexagons, and so forth, may also be imparted as desired. It is also possible to impart a third dimensional outward bulge within a surface pattern, such as illustrated in aforesaid U.S. Pat. Nos. 5,413,148 and 5,855,231 and U.S. Design Patent No. D-401,385 (all to Mintz or Mintz et al.). These knitted tubular fabrics can be made of a variety of fibers including nylon, cotton, rayon, acrylic, polyolefin and covered rubber, but the preferred fiber is polyester. They can be produced by a variety of knitting machines including circular single knit, circular double knit, rib machine and warp knitting machines, of which the preferred machine is a small diameter (4″-8″ [10-20 cm]) single knit circular knitting machine.

The inner layer 8 is made of a thin porous sheeting material that is impervious to meat solids but which is porous to passage of vapors, including water vapor, and, in many cases, also liquids including liquid water and aqueous- and organic-based liquids. This permits adequate drying of the meat by evaporation of water from the surface of the meat and also passage into the meat of desired liquids and vapors such as flavorants (e.g., smoke) and/or colorants (e.g., caramel coloring). The inner lamina must also have good wet strength to enable liquid and vapor passage without deterioration of the lamina. Suitable materials include but are not limited to open width nonwoven filter media, high wet strength papers, such as papers made from wood fiber pulp (which may include high wet strength agents such as polyamidol epichlorohydrin or melamine-formaldehyde resin), cotton fibers, or fibers such as abaca pulp (also known as Manila hemp), which are frequently used as filter media or separating membranes, particularly those which are used for teabags or fibrous casings; cellulose films and thermoplastic polymeric films (including microporous films made of polyolefin, nylon or polyester). A preferred inner lamina material is filter paper made from abaca pulp, which may be coated with cellulose or other coating to enhance its properties; abaca pulp is commonly used in fibrous casings and teabags. Desirably the inner lamia material will also have sufficient absorbency to hold and deliver accessory materials such as flavorants or colorants. (Useful descriptions of formation and properties of many suitable materials for both laminae will be found in numerous literature sources; see, e.g., Corbman, TEXTILES: FIBER TO FABRIC (5th ed., McGraw-Hill Book Co.: 1975.) From the descriptions herein those skilled in the art will be readily able to select the optimum materials for their particular end use applications.

The non-solid materials to which the inner lamina material will be permeable will be vapors and, in most cases, also liquids. All of the inner lamina materials contemplated will pass vapors, including water vapor and smoke. Many will also pass liquids, such as liquid water or aqueous- and organic-based liquids such as solutions or the liquid portion of suspensions. The papers and nonwoven filter media normally will pass both liquids and vapors. The cellulosic films and the polymeric films, however, are normally of porosities which will pass only vapors. The nonwoven filter media useful herein are those common to the industry, which are generally defined as those materials formed by being spun bonded or melt blown (both usually from polyolefin, polyester or nylon fibers) or wet laid or dry laid (both usually from microglass, cellulose or polymeric fibers). Nonwovens are considered in the art not to be knit, woven or paper materials. Passage of vapor through the inner lamina material is critical, since drying of the meat occurs by evaporation of water which exudes from the meat as vapor or liquid, and smoke, whether from liquid smoke absorbed into a lamina fabric or present as a vaporous environment surrounding the casing and meat, passes into the meat as vapor. The ability to pass liquid in addition to passing vapor is very useful and desirable in the present invention, but whether a user selects papers or nonwovens (which pass both) or cellulosic or polymeric films (which normally pass only vapors) will be merely a matter of choice based on the overall factors of the meat products and production conditions of interest to the user.

The relative porosities of the outer and inner laminae 6 and 8 will be understood by those skilled in the art of meat casings and nettings. While the specific porosity values will vary from material to material, the relevant distinction for the purpose of this invention is that the laminate's controlled porosity allows for passage of non-solids and prevents the passage of solid materials. This is considered to mean that under the normal environmental conditions of the casing's use, solid materials such as meat proteins and higher molecular weight fats will be retained within the meat, while liquid and vaporous materials such as liquid water, aqueous- and organic solutions, water vapor, liquid portions of suspensions and liquified meat components will be able to pass through the casing upon being exuded from the meat. Similarly, such non-solid materials will be able to be delivered to the meat from outside the casing or from coatings on or components within the casing if desired. Whether a particular material is a solid or non-solid will often be dependent on the internal temperature reached by the meat product during cooking or smoking (recommended internal cooking temperatures of meats are usually up to about 185° F. [85° C.]). Meat fats are normally solids at lower temperatures but as the temperature is increased, some of the fats may reach their melting temperature and will liquify. Even when liquified, however, many of the previously solid materials will still for the most part be retained within the casing since their molecular weights and configurations impede their movement though both the body of the meat and the inner lamina, so that only limited exudation occurs during the cooking or smoking process. The outer lamina may have the same degree of controlled porosity but commonly will be more porous and may be substantially of open mesh structure. Whether a particular material is suitable as an inner lamina as opposed to an outer lamina, or vice versa, in this invention can be easily determined by one skilled in the art by a simple measurement of the non-solid versus solid passage characteristics of the material for the meat product of interest.

Adhesion of the outer lamina 6 to the inner lamina 8 is through adhesive region 10. The adhesive region 10 can be an adhesive material different from but capable of adhesion to both of the laminae 6 and 8. An adhesive material can be a pressure sensitive contact adhesive material which adheres to each lamina surface upon contact and application of pressure to the adhesive and lamina, or it can be an adhesive which is activated by application of heat or radiation or by use of an activating solvent or chemical, such as by application of water. The preferred adhesion method is by use of a heat activated adhesive. The adhesive is initially present by having either or both of the two laminae contain or be coated with the adhesive material. The adhesive can be applied or present as a continuous film precoated on the contact side of either or both of the laminae, or it can be applied in a discontinuous pattern. If a continuous coating is applied, it must be one which does not itself create a barrier to permeation of the water from the meat for drying. Heat activated adhesives such as hot melt adhesives may include, but are not limited to polyethylene, polypropylene, ethylene vinyl alcohol, and the like. Since it is normally intended that the casing will be removed from the meat product by the consumer before serving the meat as a meal, the adhesive does not itself have to be edible. It will however normally be required to be of food contact grade purity and composition. If either of the laminae are made of a thermoplastic material (e.g., polyester knitted fabric or polypropylene nonwoven material), then it is necessary to select an adhesive having a significantly lower melting temperature than that of the thermoplastic lamina, so as not degrade the strength of lamina during thermal lamination. Similar considerations for avoidance of damage to the laminae will also be present for radiative, solvent or chemical activated adhesion with an adhesive material.

Alternatively, the adhesive region 10 can be a zone of direct adhesion of the two laminae to each other such as by thermal, radiative, solvent or chemical modification of the contact surfaces of the two laminae. Adhesion by thermal, radiative, solvent or chemical modification of the laminae contact surfaces themselves (i.e., “self-bonding”) will of course have different considerations than bonding with an adhesive as described above, in that the purpose here is to physically modify the contact surfaces sufficiently to cause them to form a conjoined matrix in region 10 in a manner somewhat analogous to formation of a weld between adjacent metals. Self-bonding can be considered to be interlocking of the opposing surfaces of the two laminae while in contact and which is produced by thermal, radiative, solvent or chemical induced mutual disruption of the opposing surfaces and subsequent merger and stabilization of the disrupted surfaces. Self-bonding adhesion is less desirable than use of adhesive materials because of the difficulties of obtaining a uniform adhered zone which does not materially affect the water expulsion from the meat during drying.

Manufacture of the casing product of this invention can be accomplished in various methods or steps. The inner lamina material can either be manufactured initially in continuous tubular form, such as by making an overlap seam using any of a number of known methods (e.g., heat sealing, adhesive bonding, tape application). Alternatively, conversion of the inner lamina material from sheet form into tubular form can be done simultaneously with the lamination step. In order to help prevent tearing of the inner lamina or accommodate three-dimensional profiles when subsequently stuffed with the meat product, it is preferred to form the inner material tube with a maximum circumference slightly larger than that of the outer knitted fabric lamina. The knitted tubular outer lamina fabric, conveniently at lengths of 100-1000 feet (30-300 m) at a time, is shirred onto a stiff hollow tube. The inner lamina material is then passed through the inside of the tube, in order to position the inner material inside the outer knitted tubular fabric. If, as is preferred, an adhesive material is to be used to bond the two lamina together, it may have previously been coated onto the surface of one or both of the laminae or it may have been incorporated into either or both of the laminae.

Upon the exit of the inner laminae from the tube the two laminae come into alignment, preferably with the adhesive now between them and in contact with both, and the aligned laminae and adhesive pass over an extended mandrel or spreader. The final lamination takes place while the laminae are fully spread over the mandrel. This is to ensure the consistency of the positioning of the two laminae relative to each other and to ensure that the there are no folds in either lamina, the inner lamina being especially prone to folding or kinking. Elimination of folds or kinks is important to prevent the inner lamina from tearing when stuffed with the meat product under pressure. Fully spreading the aligned laminae over the mandrel under pressure also ensures compression of the laminae during lamination, especially when using heat activation of the adhesive. For the preferred heat activated adhesive lamination method, the heat source can be provided by pulling the aligned materials and adhesive through a pair of hot nip rollers, which provides both the heat and pressure necessary.

If laminating a casing having outward three-dimensions bulges, it is preferred to have the mandrel pass through a heat tunnel and then a cooling chamber. For casings comprising design patterns which preferably contain three dimensional outward bulges (e.g., patterns of rectangle), the mandrel will need to have the capability to expand the casing to form the bulges during lamination. One method to accomplish this is by means of an inflatable, balloon-like mandrel, which alternates between being fully expanded with air under pressure to form the bulges when the casing is not advancing, and being partially deflated to allow the casing to advance the length of the mandrel for lamination of the next length of the aligned laminae.

Since many materials useful as the laminae will be absorbent, accessory materials such as flavorants (e.g., smoke flavoring), colorants (e.g., caramel coloring for dark or black colored meat products), release agents, anti-microbial agents, browning agents for golden oven roast applications and the like can be pre-applied to the laminae for added market value of the final meat product. For example, smoke can be added, which provides a desirable color and flavor to the meat, eliminating the need for the meat processor have an extra smoking step with its associated costs. Smoke may be applied as a liquid to the casing from which it vaporizes and passes into the meat as a vapor, or as a vapor from a vaporized smoke generator outside of but proximate to the encased meat, such as in a smokehouse.

The casings of this invention provide many benefits in combination to the meat processor. While some of these benefits are provided individually by prior art products, they are not found in such a broad combination in any single prior art product. Meat processors have therefore previously had to select casings knowing that any such selection necessarily meant that one or more desired properties and benefits could not be obtained from the selected casing. In the present casing device, however, a large number of benefits are for the first time found in a single product.

The casing is very durable and machinable (i.e., it is able to run in high speed meat stuffing equipment), and is strong enough to withstand the high internal stuffing pressures which are necessary to prevent voids in the meat product and give a consistent shape to the meat product. The casing is able to tolerate the extended time (e.g., eight hours) of cooking and/or smoking processes at temperatures up to 190° F. (88° C.), as well as the subsequent chilling process.

After chilling, the casing is removed before final packaging. The casing has good peelability, in that it can be removed quite easily from the meat surface since no part of the casing becomes embedded into the meat product, a common failing of prior art nettings. Downgrades due to meat tears are eliminated. Most importantly, the inner lamina material does not adhere to the meat's protein surface. Various release agents can be pre-applied to the inner surface of the casing, if necessary, to further enhance the peelability. The lamination is strong enough to hold up through all processes, so that the casing, when removed, is intact and has not delaminated, so that it does not leave any fragments on the meat product.

Good color development requires adequate surface drying. Due to the high degree of “breatheablity” of the casing and the consistency of lamination adhesive, the color development is excellent and consistent. Previously the prior art casing/netting products allowed at least some protein through, even when made of closely woven materials (like those described in the aforementioned U.S. Pat. Nos. 5,413,148 and 5,855,231) were used, which resulted in light spots appearing on the meat surface in areas where protein exudate penetrated the net and developed color on the outside of the net. The exudate was then torn away when the casing/netting product was removed, leaving the undesirable light spots on the unwrapped meat product. The casing of this invention, even when stuffed with small emulsion meat products (e.g., sausage, bologna, emulsion ham or poultry) does not allow the protein to exude through.

In addition, by having the synergistically combined porosity from the two laminae, drying or the meat product during cooking is controlled to allow for just the desired amount of drying (i.e., water removal) for optimum color development and meat texture, without affecting cooking and chilling yields. This also results in no protein being lost through the casing. Further, the controlled porosity also minimizing drip loss of moisture, especially on high pump (i.e. brine injection) products.

Stuffing and cooking, smoking and chilling procedures using the casing of this invention will be substantially the same as with prior art casings and will normally use existing stuffing equipment. As a general description, when in use the casing will normally be in the form of an extended sleeve material many feet/meters long. To form a bag-like container for each meat product a predetermined length of the leading end of the sleeve is cut from the sleeve and one end closed and secured by a collar or clip. Alternatively the extended length sleeve is shirred for continuous stuffing on an automatic stuffing machine. The meat product will then be stuffed into the open end of the sleeve, with the meat product and sleeve then conforming to substantially the desired shape of the intended commercial meat product. The casing bag will constrain the meat into the desired shape and may be such as to impart a surface pattern or texture to the meat product. Following completion of stuffing the trailing end of the bag may be closed and sealed with a collar or clip usually in the same manner as closure of the leading end of the bag. Alternatively, especially with automated stuffing equipment, a substantial quantity of meat is stuffed into the sleeve and division points are incorporated along the length of the sleeve to divide the stuffed sleeve into the desired commercial size portions. The bag containing the meat product is then transported to a cooking or smoking facility and processed for market in the conventional manner. Bag formation and sealing are illustrated in the aforementioned U.S. Pat. No. 5,855,231. Of course because of the use of the casing of this invention with its superior properties, such stuffing, cooking, smoking and subsequent chilling and packaging can be performed much more efficiently and the resulting finished meat product has the optimum properties for market.

It will be evident that there are numerous embodiments of the present invention which are not expressly described above but which are clearly within the scope and spirit of the present invention. Therefore, the above description is intended to be exemplary only, and the actual scope of the invention is to be determined from the appended claims.

I claim:

1. A casing for containment of a proteinaceous product which comprises a hollow tubular laminate comprising an outer lamina which has sufficient strength to retain and shape said contained proteinaceous product and an inner lamina of controlled porosity which is permeable to non-solids but impermeable to solids, said inner lamina and said outer lamina being adhered together.

2. A casing as in claim 1 wherein said inner lamina is porous to both vapor and liquid.

3. A casing as in claim 1 wherein said inner lamina is porous to vapor but substantially impervious to liquid.

4. A casing as in claim 1 wherein said outer lamina comprises a porous knitted fabric.

5. A casing as in claim 4 wherein said fabric comprises a knitted jersey fabric.

6. A casing as in claim 4 wherein said fabric comprises fibers of nylon, cotton, rayon, acrylic, polyolefin, covered rubber or polyester.

7. A casing as in claim 4 wherein said fabric is a knitted jersey fabric comprising fibers of polyester.

8. A casing as in claim 1 wherein said inner lamina comprises a porous sheeting material of nonwoven filter media, high wet strength paper, cellulose film or polymeric film.

9. A casing as in claim 8 wherein said nonwoven filter material comprises a spun bonded, melt blown, wet laid or dry laid material.

10. A casing as in claim 9 wherein said nonwoven filter material is formed of at least one of polyolefin, polyester, nylon, microglass, cellulosic or polymeric fibers.

11. A casing as in claim 8 wherein said high wet strength paper comprises a filter paper or membrane paper.

12. A casing as in claim 11 wherein said filter media or membrane paper comprises teabag paper or fibrous casing paper.

13. A casing as in claim 11 wherein said filter media or membrane paper comprises abaca pulp.

14. A casing as in claim 8 wherein said inner lamina comprises cellulosic film or polymeric film.

15. A casing as in claim 14 wherein said polymeric film comprises a microporous film made of polyolefin, nylon or polyester.

16. A casing as in claim 1 wherein said inner lamina and said outer lamina are adhered by an adhesive material disposed therebetween and in contact with the opposing surfaces thereof.

17. A casing as in claim 16 wherein said adhesive material comprises a pressure sensitive contact adhesive material or an adhesive which is activated by application of heat or radiation or by use of an activating solvent or chemical.

18. A casing as in claim 17 wherein said adhesive material comprises a thermally sensitive material which is activated by application of heat.

19. A casing as in claim 1 wherein said inner lamina and outer lamina are adhered by conjoined interlocking of the respective opposing surfaces thereof.

20. A casing as in claim 19 wherein said conjoined interlocking is effected by thermal, radiative, solvent or chemical induced mutual disruption of said opposing surfaces while in contact with each other and subsequent merger and stabilization of the disrupted surfaces.

21. A casing as in claim 1 wherein said laminae comprise portions which impart a formed pattern to a surface of said proteinaceous product.

22. A casing as in claim 21 wherein said pattern comprises three-dimensional elements.

23. A casing as in claim 1 further comprising an accessory material contained on the surface of or within a lamina which is transmitted to said proteinaceous product while within said casing and which imparts a desired property to said proteinaceous product.

24. A casing as in claim 23 wherein said accessory material comprises a flavorant or colorant which imparts a flavor or color respectively to said proteinaceous product

25. A casing as in claim 24 where said accessory material imparts smoke flavor or a dark color to said proteinaceous product.

26. A casing as in claim 1 wherein said controlled porosity inner lamina prevents significant exudation of proteins from said proteinaceous product.

27. A casing as in claim 26 wherein said controlled porosity inner lamina further prevents significant exudation of fats from said proteinaceous product.

28. A casing as in claim 1 for containment of said proteinaceous product wherein said proteinaceous product comprises meat, poultry, seafood, soya or cheese.

29. A casing as in claim 1 for containment of said proteinaceous product during processing of said product comprising cooking, smoking, chilling or packaging.
